(19) United States
(12) Patent Application Publication
(10) Pub. No.: US 2021/0011481 A1
(43) Pub. Date: Jan. 14, 2021

(54) APPARATUS FOR CONTROLLING BEHAVIOR OF AUTONOMOUS VEHICLE AND METHOD THEREOF

(71) Applicants: HYUNDAI MOTOR COMPANY, Seoul (KR); KIA MOTORS CORPORATION, Seoul (KR)

(72) Inventor: Dae Gil CHO, Suwon-si (KR)

(21) Appl. No.: 16/685,156

(22) Filed: Nov. 15, 2019

(30) Foreign Application Priority Data
Jul. 12, 2019 (KR) 10-2019-0084432

(51) Int. Cl. G05D 1/02; G05D 1/00; B60W 40/04; G06K 9/00; G06N 3/04

(52) U.S. Cl. CPC G05D 1/0221; G05D 1/0088; B60W 40/04; G06K 9/00825; B60W 2720/10; G06N 3/04; B60W 2550/10; B60W 2550/30; G06K 9/00335

(57) ABSTRACT

Disclosed are an apparatus for controlling the behavior of an autonomous vehicle and a method thereof. The apparatus includes a learning device that learns a behavior of a vehicle in a situation of avoiding an obstacle located on a road, and a controller that controls the behavior of the autonomous vehicle based on a learning result of the learning device.

### CROSS-REFERENCE TO RELATED APPLICATION

This application claims the benefit of priority to Korean Patent Application No. 10-2019-0084432, filed in the Korean Intellectual Property Office on Jul. 12, 2019, the entire contents of which are incorporated herein by reference.

### TECHNICAL FIELD

The present disclosure relates to a technique for controlling the behavior of an autonomous vehicle based on deep learning.

### BACKGROUND

In general, deep learning or a deep neural network, which is a kind of machine learning, may include several layers of artificial neural networks between the input and output. Such an artificial neural network may include a convolutional neural network (CNN), a recurrent neural network (RNN), and the like according to the structure, and the problem to be solved, the purpose, and the like.

Data input to the convolutional neural network is divided into a training set and a test set. The convolutional neural network learns the weight of the neural network through the training set and checks the learning result through the test set.

In such a convolutional neural network, when data are input, the operation proceeds step by step from the input layer to the hidden layer, and the result is output. In this process, the input data pass through all nodes only once.

The process in which the input data passes through all nodes only once means a structure which does not consider the order of data, that is, the temporal aspect. Thus, the convolutional neural network performs learning regardless of the temporal order of the input data.

Meanwhile, the recurrent neural network has a structure in which the result of the hidden layer is input back to the hidden layer. This structure means that the temporal order of the input data is taken into account.

According to an apparatus for controlling a behavior of an autonomous vehicle according to the related art, even though an obstacle (e.g., a fallen object, a pothole, an unevenness, or the like) that interferes with the traveling of the autonomous vehicle is located in front of the traveling road, when the obstacle is hidden by a preceding vehicle, the obstacle is not sensed by a sensor so that it is difficult to detect the obstacle.

Even though an obstacle that is not sensed is located on a road, the apparatus for controlling a behavior of an autonomous vehicle according to the related art cannot avoid the obstacle or reduce the speed to relieve the impact caused by the obstacle, so that it is difficult to provide an optimal riding comfort to an occupant of the autonomous vehicle and a big accident may be caused, so there is a need to provide a coping scheme.

### SUMMARY

The present disclosure has been made to solve the above-mentioned problems occurring in the prior art while advantages achieved by the prior art are maintained intact.

An aspect of the present disclosure provides an apparatus for controlling a behavior of an autonomous vehicle, which is capable of deeply learning the behavior of a vehicle in a situation of avoiding an obstacle (e.g., a fallen object, a pothole, an unevenness, or the like) located on a road and controlling obstacle avoidance of the autonomous vehicle based on the learning result to prevent in advance collision with the obstacle that is hidden and not detected due to a preceding vehicle and provide an optimal riding comfort to an occupant of the autonomous vehicle, and a method thereof.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for controlling a behavior of an autonomous vehicle includes a learning device that learns a behavior of a vehicle in a situation of avoiding an obstacle located on a road, and a controller that controls the behavior of the autonomous vehicle based on a learning result of the learning device.

The apparatus may further include a sensor that senses a behavior of a preceding vehicle traveling in a same lane as the autonomous vehicle.

The sensor may sense lateral and vertical behaviors of the preceding vehicle. In this case, the vertical behavior may include a vertical behavior of a left portion of the body of the preceding vehicle and a vertical behavior of a right portion of the body of the preceding vehicle.

The controller may apply the lateral behavior of the preceding vehicle sensed by the sensor to the learning result of the learning device to estimate whether the obstacle exists.

The controller may control the behavior of the autonomous vehicle to follow the lateral behavior of the preceding vehicle when the obstacle exists.

The controller may apply the vertical behavior of the preceding vehicle sensed by the sensor to the learning result of the learning device to estimate whether the obstacle exists.

The controller may reduce a speed of the autonomous vehicle when the obstacle exists.

The learning device may perform learning based on a recurrent neural network (RNN).

According to another aspect of the present disclosure, a method of controlling a behavior of an autonomous vehicle includes learning, by a learning device, a behavior of a vehicle in a situation of avoiding an obstacle located on a road, and controlling, by a controller, the behavior of the autonomous vehicle based on a learning result of the learning device.

The method may further include sensing, by a sensor, a behavior of a preceding vehicle traveling in a same lane as the autonomous vehicle.

The sensing of the behavior of the preceding vehicle may include sensing a lateral behavior of the preceding vehicle, and sensing a vertical behavior of the preceding vehicle.

The sensing of the vertical behavior may include sensing a vertical behavior of a left portion of the body of the preceding vehicle, and sensing a vertical behavior of a right portion of the body of the preceding vehicle.

The controlling of the behavior of the autonomous vehicle may include applying the lateral behavior of the preceding vehicle sensed by the sensor to the learning result of the learning device to estimate whether the obstacle exists, and controlling the behavior of the autonomous vehicle to follow the lateral behavior of the preceding vehicle when the obstacle exists.

The controlling of the behavior of the autonomous vehicle may include applying the vertical behavior of the preceding vehicle sensed by the sensor to the learning result of the learning device to estimate whether the obstacle exists, and reducing a speed of the autonomous vehicle when the obstacle exists.

The learning of the behavior of the vehicle may be performed based on a recurrent neural network (RNN).

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an apparatus for controlling a behavior of an autonomous vehicle according to an embodiment of the present disclosure;

FIG. 2 is a view illustrating an image taken by the camera provided in an apparatus for controlling a behavior of the autonomous vehicle according to an embodiment of the present disclosure;

FIG. 3 is a view illustrating the behavior of a preceding vehicle measured by a sensor provided in an apparatus for controlling a behavior of an autonomous vehicle according to an embodiment of the present disclosure;

FIGS. 4A and 4B are diagrams illustrating a lateral behavior of a preceding vehicle determined by a controller according to an embodiment of the present disclosure;

FIGS. 5A to 5C are views illustrating the vertical behavior of a preceding vehicle determined by a controller according to an embodiment of the present disclosure;

FIG. 6 is a flowchart illustrating a method of controlling a behavior of an autonomous vehicle according to an embodiment of the present disclosure; and

FIG. 7 is a view illustrating a computing system that executes a method of controlling a behavior of an autonomous vehicle according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

In an embodiment of the present disclosure, an autonomous vehicle means a vehicle that is driven without the operation of a driver, and the vehicle and the preceding vehicle mean vehicles that are driven by the operations of drivers.

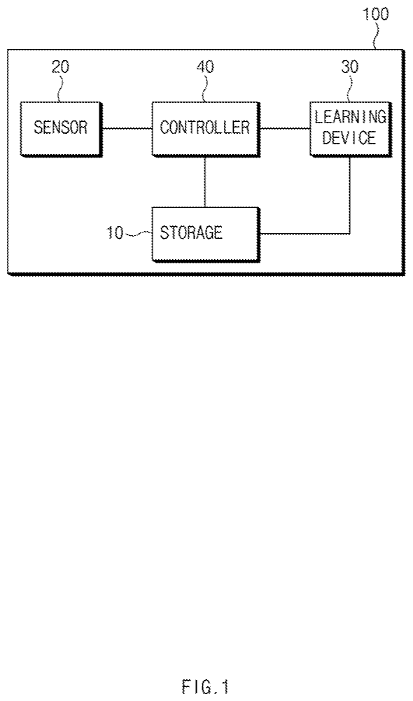

FIG. 1 is a block diagram illustrating an apparatus for controlling a behavior of an autonomous vehicle according to an embodiment of the present disclosure.

As shown in FIG. 1, an apparatus 100 for controlling a behavior of an autonomous vehicle according to an embodiment of the present disclosure may include storage 10, a sensor 20, a learning device 30, and a controller 40. In this case, according to a scheme of implementing the apparatus 100 for controlling a behavior of an autonomous vehicle according to an embodiment of the present disclosure, components may be combined with each other and implemented as one, and some components may be omitted. In particular, the learning device 30 may be merged with the controller 40 such that the controller 40 may be implemented to perform the function of the learning device 30.

Inspecting each component, first, the storage 10 may store various logics, algorithms, and programs required in the process of deeply learning the behavior of the vehicle in the situation of avoiding an obstacle (e.g., a fallen object, a pothole, an unevenness, or the like) located on the road and controlling the obstacle avoidance of the autonomous vehicle based on the learning result.

The storage 10 may store an obstacle avoidance behavior model generated as the learning result of the learning device 30.

The storage 10 may include at least one type of a storage medium of memories of a flash memory type, a hard disk type, a micro type, a card type (e.g., a secure digital (SD) card or an extreme digital (XD) card), and the like, and a random access memory (RAM), a static RAM, a read-only memory (ROM), a programmable ROM (PROM), an electrically erasable PROM (EEPROM), a magnetic memory (MRAM), a magnetic disk, and an optical disk type memory.

Next, the sensor 20 may be mounted on the autonomous vehicle that is driving the road, and may sense the behavior of the preceding vehicle that is driving the same lane as the autonomous vehicle. In this case, the sensor 20 may sense the lateral and vertical behaviors of the preceding vehicle. In this case, the vertical behavior may include the vertical behaviors of the left and right portions of the body of the preceding vehicle. That is, when the left wheel of the preceding vehicle passes through a pothole, the vertical behavior of the left portion of the body of the preceding vehicle may occur. When the right wheel of the preceding vehicle passes through a pothole, the vertical behavior of the right portion of the body of the preceding vehicle may occur.

The sensor 20 may include a light detection and ranging (LiDAR) sensor, a camera, a radio detecting and ranging (RaDAR) sensor, an ultrasonic sensor, and the like.

For reference, the LiDAR sensor, which is a kind of environmental awareness sensor, is mounted on an autonomous vehicle to measure the position coordinates of a reflector and the like based on the time when the laser is reflected back and forth in all directions while being rotated.

The camera is mounted in front of the autonomous vehicle to take an image including a lane, a vehicle, an obstacle, and the like around the autonomous vehicle.

The RaDAR sensor receives an electromagnetic wave reflected from an object after emitting the electromagnetic wave, thereby measuring the distance to the object, the direction of the object, and the like. The RaDAR sensor may be mounted on the front bumper and the rear side of the autonomous vehicle, and may recognize a long distance object. The RaDAR sensor is hardly affected by weather.

Hereinafter, although an embodiment of the present disclosure is described by taking a camera as an example, the embodiment is not necessarily limited thereto.

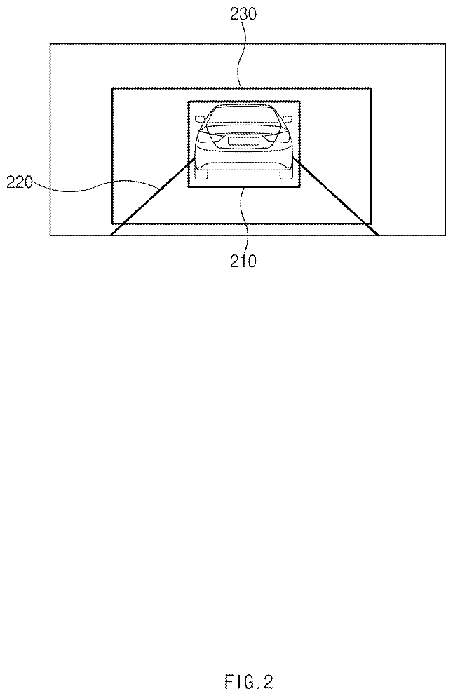

FIG. 2 is a view illustrating an image taken by the camera provided in an apparatus for controlling a behavior of the autonomous vehicle according to an embodiment of the present disclosure.

As shown in FIG. 2, the camera provided in an apparatus for controlling a behavior of the autonomous vehicle according to an embodiment of the present disclosure may photograph the front image of the autonomous vehicle. The photographed front image may include a preceding vehicle 210 and a lane 220.

Next, the learning device 30 may deeply learn the behavior (learning data) of the vehicle in a situation of avoiding an obstacle located on the road. In this case, the learning device 30 may perform in-depth learning based on a recurrent neural network (RNN). For reference, because the RNN has a structure in which the output of the hidden layer is input to the hidden layer again, the learning device 30 may consider the temporal order of the input data.

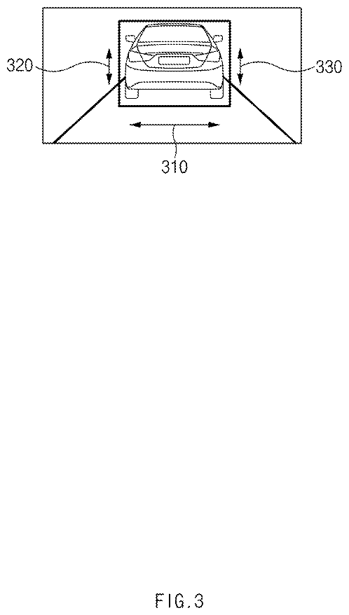

In this case, the behavior of the vehicle may include lateral and vertical behaviors. For example, as shown in FIG. 3, the behavior of the vehicle may include a lateral behavior 310 and vertical behaviors 320 and 330 of the preceding vehicle 210.

FIG. 3 is a view illustrating the behavior of a preceding vehicle measured by a sensor provided in an apparatus for controlling a behavior of an autonomous vehicle according to an embodiment of the present disclosure.

In FIG. 3, reference numeral ‘320’ indicates a vertical behavior of a left portion of the body of the preceding vehicle 210 and reference numeral ‘330’ indicates a vertical behavior of a right portion of the body of the preceding vehicle 210.

The learning device 30 may generate an obstacle avoidance behavior model of an autonomous vehicle as a learning result. In this case, the obstacle avoidance behavior model may include the deceleration behavior of the autonomous vehicle corresponding to the vertical behavior of the preceding vehicle 210 as well as the lateral behavior of the autonomous vehicle corresponding to the lateral behavior of the preceding vehicle 210.

Next, the controller 40 performs the overall control to allow each component to perform its function. The controller 40 may be implemented in hardware or software, and of course, may be implemented in the form of a combination of hardware and software. Preferably, the controller 40 may be implemented with a microprocessor, but the embodiment is not limited thereto.

Specifically, the controller 40 may perform various controls required in the process of deeply learning the behavior of the vehicle in the situation of avoiding an obstacle (e.g., a fallen object, a pothole, an unevenness, or the like) located on the road and controlling the obstacle avoidance of the autonomous vehicle based on the learning result.

In addition, the controller 40 may perform various controls required in the process of deeply learning the behavior of the vehicle in the situation of avoiding an obstacle (e.g., a fallen object, a pothole, an unevenness, or the like) located on the road and controlling the speed of the autonomous vehicle based on the learning result.

The controller 40 may detect the preceding vehicle 210 and the lane 220 in the front image photographed by the camera.

The controller 40 may set a region of interest (ROI) 230 including the preceding vehicle 210 and the lane 220 on the front image photographed by the camera. In this case, the controller 40 may determine whether the behavior of the preceding vehicle 210 is caused by an obstacle or a simple driving based on the lane 220 in the ROI 230.

When the preceding vehicle 210 returns to the original position after a sudden lateral behavior occurs, the controller 40 may determine that an obstacle exists when a sudden vertical behavior occurs in the preceding vehicle 210.

Hereinafter, the process of controlling, by the controller 40, the behavior of the autonomous vehicle based on the learning result of the learning device 30 will be described in detail.

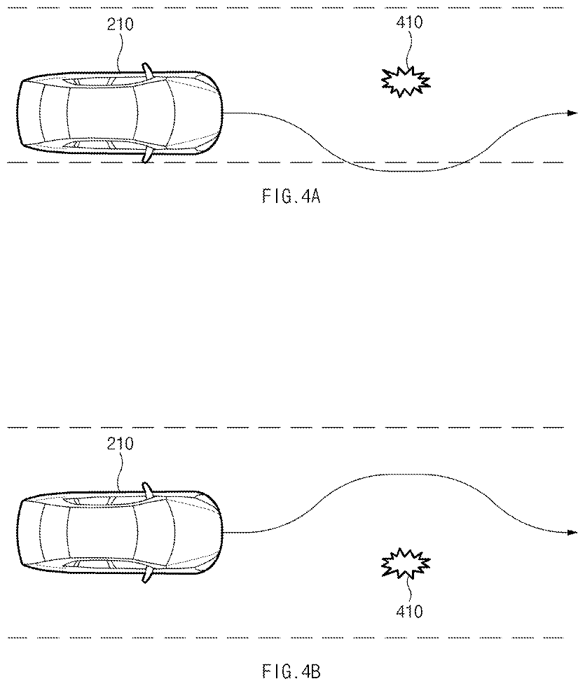

FIGS. 4A and 4B are diagrams illustrating a lateral behavior of a preceding vehicle determined by a controller according to an embodiment of the present disclosure.

As shown in FIG. 4A, when an obstacle 410 is located at the front left side of the preceding vehicle 210 running on the road, the preceding vehicle 210 moves to the right side of the lane to avoid collision with the obstacle 410 and then returns to the center of the lane. That is, the lateral behavior of the preceding vehicle 210 occurs due to the obstacle 410. In this case, the preceding vehicle 210 is driven by the operation of a driver.

As shown in FIG. 4B, when the obstacle 410 is located at the front right side of the preceding vehicle 210, the preceding vehicle 210 moves to the left side of the lane to avoid collision with the obstacle 410 and then returns to the center of the lane. That is, the lateral behavior of the preceding vehicle 210 occurs due to the obstacle 410. In this case, the preceding vehicle 210 is driven by the operation of a driver.

The controller 40 may estimate whether the obstacle 410 exists by applying the lateral behavior 310 of the preceding vehicle 210 sensed by the sensor 20 to the learning result of the learning device 30. In this case, the controller 40 may control the behavior of the autonomous vehicle to allow the autonomous vehicle to follow the lateral behavior of the preceding vehicle 210 when it is estimated that the obstacle 410 exists. That is, the controller 40 avoids obstacles by following the lateral behavior of the preceding vehicle 210.

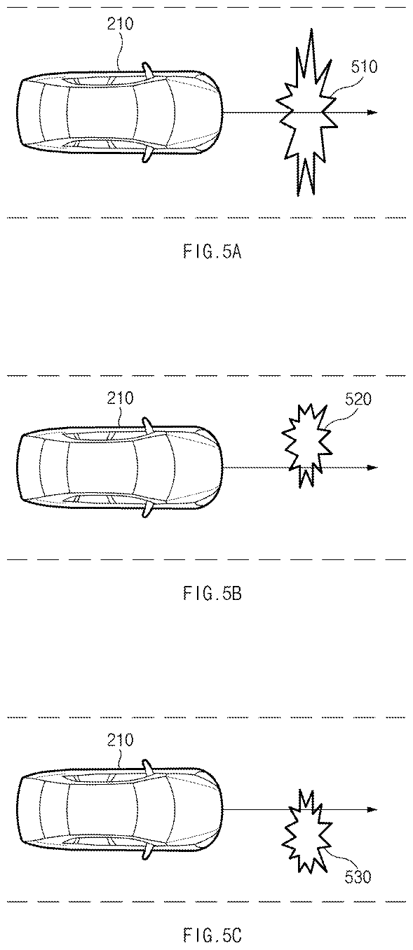

FIGS. 5A to 5C are views illustrating the vertical behavior of a preceding vehicle determined by a controller according to an embodiment of the present disclosure.

As shown in FIG. 5A, when a pothole 510 is located in the entire area in front of the preceding vehicle 210 running on a road, that is, all the wheels of the preceding vehicle 210 cannot avoid the pothole 510, both the left and right vertical behaviors 320 and 330 occur in the preceding vehicle 210 in the process of passing through the pothole 510.

The controller 40 may apply the vertical behaviors of the left and right portions 320 and 330 of the preceding vehicle 210 sensed by the sensor 20 to the learning result of the learning device 30 to estimate whether there exists the pothole 510. In this case, when the existence of the pothole 510 is estimated, the controller 40 may control the deceleration behavior of the autonomous vehicle. That is, the controller 40 reduces the speed of the autonomous vehicle to the first reference speed to minimize the impact caused by the pothole 510.

As shown in FIG. 5B, when the pothole 520 is located in the front left area of the preceding vehicle 210, the vertical behavior of the left portion 320 of the preceding vehicle 210 occurs in the process of passing through the pothole 520.

The controller 40 may apply the vertical behavior of the left portion 320 of the preceding vehicle 210 sensed by the sensor 20 to the learning result of the learning device 30 to estimate whether there exists the pothole 520. In this case, when it is estimated that the pothole 520 exists, the controller 40 may control the deceleration behavior of the autonomous vehicle. That is, the controller 40 reduces the speed of the autonomous vehicle to the second reference speed to minimize the impact caused by the pothole 520.

As shown in FIG. 5C, when the pothole 530 is located in the front right area of the preceding vehicle 210, the vertical behavior of the right portion 330 of the preceding vehicle 210 occurs in the process of passing through the pothole 530.

The controller 40 may apply the vertical behavior of the right portion 330 of the preceding vehicle 210 sensed by the sensor 20 to the learning result of the learning device 30 to estimate whether there exists the pothole 530. In this case, when it is estimated that the pothole 530 exists, the controller 40 may control the deceleration behavior of the autonomous vehicle. That is, the controller 40 reduces the speed of the autonomous vehicle to the second reference speed to minimize the impact caused by the pothole 530.

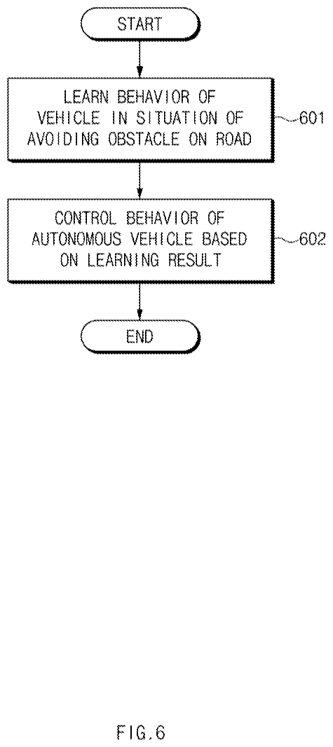

FIG. 6 is a flowchart illustrating a method of controlling a behavior of an autonomous vehicle according to an embodiment of the present disclosure.

First, in operation 601, the learning device 30 deeply learns the behavior of a vehicle in a situation of avoiding obstacles on a road.

Then, in operation 602, the controller 40 controls the behavior of an autonomous vehicle based on a learning result of the learning device 30. In this case, when it is determined that the lateral behavior of the preceding vehicle 210 is for obstacle avoidance, the controller 40 follows the lateral behavior of the preceding vehicle 210 to avoid the obstacle. In addition, when it is determined that the vertical behavior of the preceding vehicle 210 is caused by the obstacle, the controller 40 reduces the speed of the autonomous vehicle to minimize the impact caused by the obstacle.

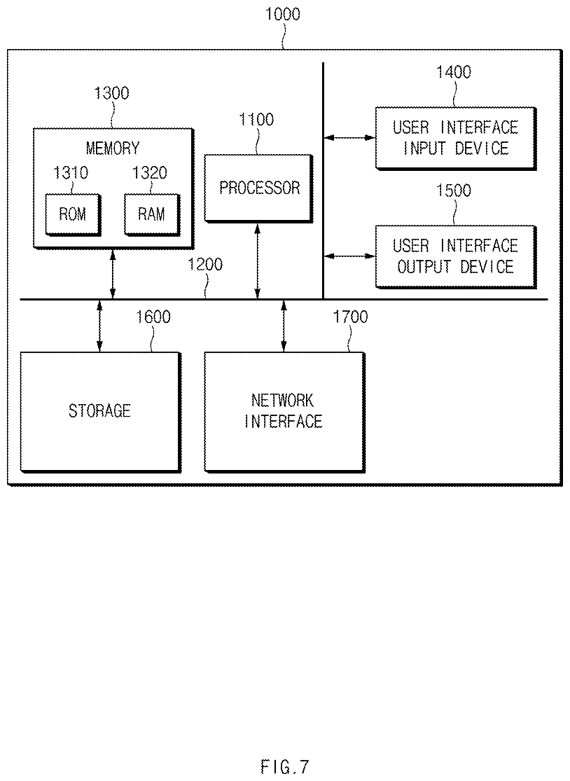

FIG. 7 is a view illustrating a computing system that executes a method of controlling a behavior of an autonomous vehicle according to an embodiment of the present disclosure.

Referring to FIG. 7, a method of controlling a behavior of an autonomous vehicle according to an embodiment of the present disclosure may be implemented through a computing system. A computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to an apparatus and method for controlling a behavior of an autonomous vehicle of the present disclosure, by deeply learning the behavior of a vehicle in a situation of avoiding an obstacle (e.g., a fallen object, a pothole, an unevenness, or the like) located on a road and controlling obstacle avoidance of the autonomous vehicle based on the learning result, it is possible to prevent in advance collision with the obstacle that is hidden and not detected due to a preceding vehicle and provide an optimal riding comfort to an occupant of the autonomous vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for controlling a behavior of an autonomous vehicle, the apparatus comprising:
a learning device configured to learn a behavior of a vehicle in a situation of avoiding an obstacle located on a road; and
a controller configured to control the behavior of the autonomous vehicle based on a learning result of the learning device.

2. The apparatus of claim 1, further comprising:
a sensor configured to sense a behavior of a preceding vehicle traveling in a same lane as the autonomous vehicle.

3. The apparatus of claim 2, wherein the sensor is configured to sense lateral and vertical behaviors of the preceding vehicle.

4. The apparatus of claim 3, wherein the vertical behavior includes a vertical behavior of a left portion of a body of the preceding vehicle and a vertical behavior of a right portion of a body of the preceding vehicle.

5. The apparatus of claim 3, wherein the controller is configured to apply the lateral behavior of the preceding vehicle sensed by the sensor to the learning result of the learning device to estimate whether an obstacle exists.

6. The apparatus of claim 5, wherein the controller is configured to control the behavior of the autonomous vehicle to follow the lateral behavior of the preceding vehicle when the obstacle exists.

7. The apparatus of claim 3, wherein the controller is configured to apply the vertical behavior of the preceding vehicle sensed by the sensor to the learning result of the learning device to estimate whether an obstacle exists.

8. The apparatus of claim 7, wherein the controller is configured to reduce a speed of the autonomous vehicle when the obstacle exists.

9. The apparatus of claim 1, wherein the learning device is configured to perform learning based on a recurrent neural network (RNN).

10. The apparatus of claim 1, wherein the controller comprises a microprocessor.

11. The apparatus of claim 1, wherein the learning device is configured to include a temporal order of data input to the learning device as learning data.

12. A method of controlling a behavior of an autonomous vehicle, the method comprising:
learning, by a learning device, a behavior of a vehicle in a situation of avoiding an obstacle located on a road; and
controlling, by a controller, the behavior of the autonomous vehicle based on a learning result of the learning device.

13. The method of claim 12, further comprising:
sensing, by a sensor, a behavior of a preceding vehicle traveling in a same lane as the autonomous vehicle.

14. The method of claim 13, wherein the sensing of the behavior of the preceding vehicle includes:
sensing a lateral behavior of the preceding vehicle; and
sensing a vertical behavior of the preceding vehicle.

15. The method of claim 14, wherein the sensing of the vertical behavior includes:
sensing a vertical behavior of a left portion of a body of the preceding vehicle; and
sensing a vertical behavior of a right portion of a body of the preceding vehicle.

16. The method of claim 14, wherein the controlling of the behavior of the autonomous vehicle includes:
applying the lateral behavior of the preceding vehicle sensed by the sensor to the learning result of the learning device to estimate whether an obstacle exists; and
controlling the behavior of the autonomous vehicle to follow the lateral behavior of the preceding vehicle when the obstacle exists.

17. The method of claim 15, wherein the controlling of the behavior of the autonomous vehicle includes:
applying the vertical behavior of the preceding vehicle sensed by the sensor to the learning result of the learning device to estimate whether an obstacle exists; and
reducing a speed of the autonomous vehicle when the obstacle exists.

18. The method of claim 12, wherein the learning of the behavior of the vehicle is performed based on a recurrent neural network (RNN).

19. The method of claim 12, wherein the controller comprises a microprocessor.

20. The method of claim 12, wherein the learning device is configured to include a temporal order of data input to the learning device as learning data.
